(19) United States
(12) Patent Application Publication
(10) Pub. No.: US 2004/0150262 A1
(43) Pub. Date: Aug. 5, 2004

(54) Method for control of a braking device on a motor vehicle and braking device

(76) Inventors: Ralph Gronau, Wetter (DE); Tobias Scheller, Frankfurt (DE); Ralf Reviol, Dietzenbach-Steinberg (DE)

Correspondence Address: Gerlinde M Nattler, Continental Teves Inc, One Continental Drive, Auburn Hills, MI, 48326, US

(21) Appl. No.: 10/467,423

(22) PCT Filed: Feb. 6, 2002
(86) PCT No.: PCT/EP02/01207

(30) Foreign Application Priority Data
Feb. 21, 2001 (DE) 101 08 355.6
Dec. 21, 2001 (DE) 101 63 524.9

(51) Int. Cl. B60T 13/66

(52) U.S. Cl. 303/191; 303/20

(57) ABSTRACT

The present invention relates to a method of actuating a braking device for motor vehicles with electrically controlled hydraulic valves and a hydraulic pump, in which one or more existing valve coils necessary for hydraulic controlling functions are actuated for the purpose of electrically heating one or more support members accommodating these coils, for longer periods of time than is necessary for the control function and/or in periods in which it is not necessary for the control function, wherein at least one first heating period is carried out, and with the heating period comprising a first heating pulse followed by a heating pause and at least one further heating pulse.

The present invention relates to a method of actuating a braking device in a motor vehicle according to the preamble of claim 1, as well as a braking device according to claim 16.

A hydraulic brake system in passenger vehicles usually comprises a pedal-operated braking pressure generator that transmits the generated pressure in a pressure fluid (e.g. hydraulic fluid) to the wheel brake cylinders by way of pressure lines, subdivided into two brake circuits. In order to avoid wheel lock, an electrohydraulic control unit modulates the wheel brake pressures in anti-lock brake systems. The hydraulic part of the control unit (HCU) comprises pressure modulation valves for this purpose, such as an inlet and an outlet valve per wheel brake cylinder, and the valves' switch conditions determine whether pressure fluid is taken from the wheel brakes for pressure reduction or pressure fluid is supplied to them for pressure increase. Another component is a hydraulic pump that supplies pressure fluid into the brake circuit as a substitute for the pressure fluid removed for modulation of the wheel braking pressures. The so-called return delivery principle is frequently employed in which the pump is designed as a non-self-priming or self-priming return pump returning the pressure fluid removed from the wheel brakes by way of the open outlet valve and/or subsequent low-pressure accumulators directly into the brake circuit upstream of the inlet valve.

An anti-lock vehicle brake system of this type with a so-called ABS function may now be improved to become a brake system with driving stability or traction slip control (ESP or TCS function). During traction slip control, pressure is built up in the wheel brakes of the driven wheels, and the brake torque produced in this action will counteract the driving torque until said is reduced to an extent that can be supported in the contact surfaces of the driven wheels. Consequently, incipient spinning of the wheels during start up is prevented by means of this method.

In a driving stability control operation, braking pressure is built up at each individual wheel of the vehicle so that the brake forces produced thereby will produce a torque about the vertical axis of the vehicle, said torque counteracting an excessively high yaw rate of the vehicle.

A common feature in these two control systems and some other control systems not mentioned is that wheel braking pressure must be produced in individual or all of the wheel brakes without pedal application. Therefore, these braking operations are referred to as independent force assisted braking operations in contrast to the so-called partial braking operations without independent force. In an independent force assisted braking operation, the wheel brakes must be filled with pressure fluid in a filling period in order to produce the desired braking pressure. To be able to modulate the wheel braking pressure acting in the wheel brakes, one inlet valve and one outlet valve is provided for each wheel brake. Both valves are actuated electromagnetically by way of actuation of valve coils, and the inlet valve is normally open and the outlet valve normally closed in prior art control systems. The inlet valve is disposed in the brake line, while the outlet valve constitutes in each case the connection to a low-pressure accumulator. Further, a change-over valve and a separating valve operable by way of valve coils are provided. The separating valve is disposed in the brake line, while the change-over valve is inserted into a connecting line between the suction side of the return pump and the tandem master cylinder reservoir.

In an independent force assisted braking operation, for dynamic reasons the self-priming hydraulic pump of the control system is used to build up pressure. It has shown that this pump is not capable in all cases of solely building up the required braking pressure at a sufficient rate.

It is known in the art that the viscosity of brake fluid or hydraulic fluid is highly responsive to temperature. High viscosity at low fluid temperatures in the start-up period of a motor vehicle, especially at low outside temperatures, impairs the increase in braking pressure of a controlled hydraulic brake system. This entails special problems in terms of a driving stability control function because in this feature brake fluid shall be conducted from the brake fluid reservoir to a wheel brake particularly rapidly. The viscosity of brake fluid rises overproportionately at declining temperatures. At temperatures below −20° C. the result is that brake fluid cannot be aspirated sufficiently quickly and, in addition, pressure loss in the pipeline increases with rising viscosity. These obstacles cause a temporally lessened function of driving stability control. In order to improve the existing systems, it is desired to safeguard a quick, independent braking intervention even at low temperatures. To overcome this problem, WO 96/20102 (P 7792) disclosed already devices arranging for an auxiliary pressure source or a pre-charge pump. However, considerable additional cost is incurred thereby so that solutions to this problem without an auxiliary pressure source are now as before searched for.

One possibility of solving this problem is presented in German patent application P 10059348.8 (P 9750). According to the method disclosed therein, brake fluid is heated up to an increased, uncritical temperature by way of a heat transfer medium by electrically actuating (energizing) the available valve coils that are not necessary for hydraulic control functions deliberately for periods of time longer than necessary for the control function and/or deliberately in intervals in which it is unnecessary for the control function, such actuation being carried out for the purpose of electrically heating the support member which accommodates the coils and, in particular, is a metal and massive member (valve block).

An object of the present invention is to improve upon the function of the brake system described in P 10059348.8 to such end that the temperature range in which the automatic braking function is maintained, is extended towards lower temperatures without thereby increasing the structural mechanical effort of the braking device.

This object is achieved by a method according to claim 1.

Favorable improvements of the invention are indicated in the sub claims.

As is known, it is possible to utilize the internal ohmic resistance by electrically energizing, e.g. by a longer lasting opening/closing, the electrohydraulic valve coils in such a fashion that a considerable heating capacity for heating the hydraulic fluid is achieved in the valve coils. The heating energy is transmitted from the coils to the hydraulic fluid essentially by heat conduction, but to a small extent also by heat radiation and heat convection. Besides a direct heat flow to the hydraulic fluid, heat energy is substantially entered by way of the so-called valve block in which the valves are embedded. Due to heat conduction and convection the viscosity of the heated brake fluid is lessened until into the suction lines. Heating the brake fluid by way of the energized valve is carried out statically when the brake fluid is not flowing as well as dynamically according to the principle of a continuous flow heater when the hydraulic fluid flows through the valve. For heating at least one first heating period is realized according to the invention, said heating period comprising a first heating impulse and at least one further heating impulse.

For varying the input heating capacity it is possible to actuate one, several, or all of the coils available in the valve block. It is preferred that the heating capacity is varied in dependence on the driving condition of the motor vehicle because not in all driving conditions access to all valve coils is possible or allowed. Thus, it is mandated by law, e.g. for reasons of safety, that it is imperative to always maintain a closed hydraulic connection during wheel brake cylinder and master brake cylinder during driving.

With a pulsed or continuous actuation, the current strength for actuating the valves is preferably chosen to be at a rate sufficient to open the respective valve when it is normally closed or, respectively, close it when it is normally open.

It is alternatively possible that the valves for heating are actuated with pulses of a current strength or pulse duration so chosen that the energized valve is not yet switched mechanically. For a corresponding procedure especially those valves are useful which do not adopt an intermediate position between opened and closed condition at correspondingly appropriate heating currents. It is thus possible to use also those valves that are not available for a switching actuation only in defined driving situations, or are never available.

A favorable point of time for heating is e.g. the driving situation directly after starting of the motor vehicle.

When the ignition is switched off during an above-mentioned heating pulse or a heating period that may comprise several pulse/pause sequences, it will preferably be safeguarded according to the method of the invention that a cooling period (heating pause) of sufficient duration, especially for a duration of several minutes, is maintained. This means that no new heating pulse or a new heating period is started before the respective hydraulic valve has not been energized for a sufficient time. This mode of operation avoids a local overheating of the hydraulic valve due to too frequent consecutive heating or due to boiling of the hydraulic fluid caused by overheating.

A driving situation allowing actuation of the electronic change-over valves or, as the case may be, of further utilizable valves may be detected in a particular suitable fashion by the electronic control unit interrogating the brake light switch. When the brake light switch is activated, energization of the valve(s) employed for heating will be interrupted or terminated.

The hydraulic valves can be actuated either by a ‘control’ (comprises actively or passively developed braking pressure) that is initiated by the electronic control unit, or by a ‘normal braking operation’ meaning a standard-type application of the brake by the driver, i.e., without anti-lock control activated. In a preferred manner, the method of the invention is implemented in dependence on the type of control (‘control’ or ‘normal braking operation’) according to different criteria. When a ‘control’ takes place within a heating period or a heating pulse, the current heating period or the current heating pulse is discontinued immediately. Expediently, if this is necessary due to the current temperature of the block, the instantaneous heating pulse and/or the instantaneous heating period is continued at the point it was interrupted. In a particularly preferred manner this is done by re-starting a second or any further heating pulse so that the heating period is basically continued. The cooling period is, however, thereby interrupted and will only be continued after the end of control.

‘Normal braking’ occurring during a heating pulse or heating period is preferably attributed to the cooling period (heating pause), but the heating period or the heating pulse will be interrupted and, if necessary, continued at a later time.

Besides, it is suitable that it is constantly checked during a heating period whether a measured temperature in the valve block exceeds a predetermined threshold temperature (T_{OFF}). If this is the case, the current heating period will be stopped at once.

According to a preferred embodiment of the invention, at least one of the valve coils actuated for heating purposes is associated with a change-over valve connecting the suction side of the hydraulic pump to a hydraulic reservoir (electronic change-over valve) in an energized or actuated heating function. It is alternatively possible to actuate all available valve coils in driving situations appropriate for actuating all valve coils, if the brake system's safety concept allows this procedure.

One or more temperature sensors preferably sense the measured temperature, and the corresponding electric temperature signal(s) is/are relayed to a control unit operating the solenoid valves. Expediently, the temperature sensor(s) is/are fitted directly into the valve block. Redundant measuring arrangements for temperature measurement are preferred to increase the reliability of operation. In addition, still further temperature data existing in the vehicle can be used. The term ‘temperature measurement’ not only refers to the physical polling of a corresponding temperature sensor but also to reading out a memory location in which a current temperature value is stored.

Furthermore, it may be suitable in the nature of the method that the control of the nominal braking pressure being conducted in the control unit is changed in response to the temperature data and the steps of heating implemented to such end that the actually reached braking pressure will correspond more precisely to the theoretical value relating to the braking pressure.

Preferably, the brake circuits exhibit a black-and-white brake circuit allotment or a diagonal brake circuit allotment.

The valve coils actuated for heating purposes are suitably excluded from the energization performed for heating purposes for the duration of the activation in a conventional brake application (partial braking) without control intervention effected by the electrohydraulic brake control unit, because it cannot be ruled out in every case that the valves actuated by means of the valve coils influence the braking operation.

Furthermore, the invention proposes a braking device for motor vehicles, which especially is a hydraulic braking system, wherein an electronic processing unit (control unit) performs the method described hereinabove. Said method is preferably implemented by executing a program in one or more microcomputers of the processing unit. It is, however, also possible that the method is implemented by a microelectronic, programmable or hard-wired logic.

The method of the invention may also be applied in brake systems with valves of analog operation such as in a control unit for an electrohydraulic brake system (EHB).

An embodiment of the invention will be described in the following.

In the drawings,

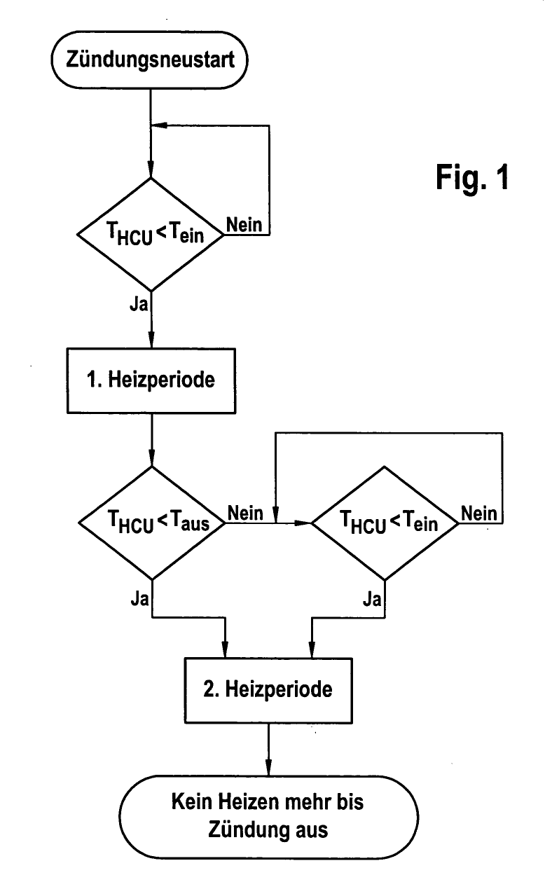

FIG. 1 is a schematic view of the method according to the invention with two heating periods.

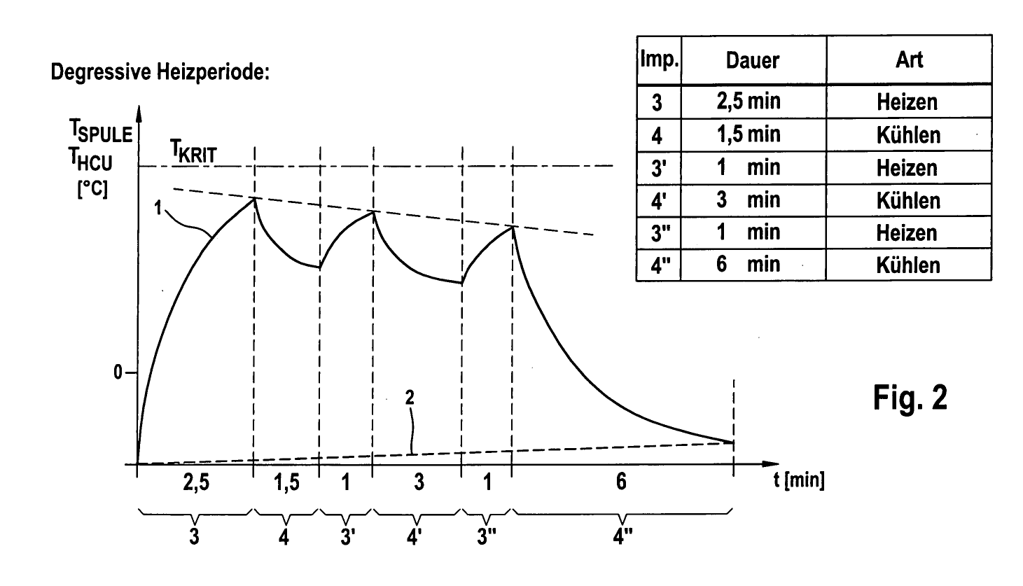

FIG. 2 is a diagram for explaining the temperature variations and the heating pulses in an individual heating period.

After the ignition has been switched on, the temperature T_{HCU} in the area of the valve block measured by a temperature sensor in the valve block is compared with a predetermined first threshold temperature T_{ON} according to FIG. 1. If the temperature of the valve block is lower than T_{ON}, the first heating period is performed with six heating pulses as explained in connection with FIG. 2.

Following the first heating period is another temperature comparison between T_{HCU} and a second threshold temperature T_{OFF}, with T_{ON}<T_{OFF} applying. When the valve block temperature T_{HCU} is lower than T_{OFF}, a second heating period is started instantaneously, which preferably corresponds to the heating pattern of the first heating period. Otherwise, one will wait until the valve block temperature T_{HCU} becomes inferior to the lower predetermined first threshold temperature T_{ON}.

Upon completion of the second heating period, expediently, no further heating period is performed until the vehicle is switched off (signal ‘ignition off’).

The valve coils are actuated within the first or the second heating period according to the pulse pattern illustrated in FIG. 2. Curve 1 indicates the current coil temperature T_{COIL}, which cannot be determined directly in the control unit in close proximity to the coil because of lack of sensors. As stated before, it is significant to avoid that a critical coil temperature T_{CRIT} is exceeded. Otherwise, overheating of the coil winding could entail damage to the brake system or overheating of the brake fluid. Curve 2 illustrates the variation of the temperature of a temperature sensor rising during a heating period in the area of the valve block. The coils are actuated with a square pulse current pattern within the heating period. In the time ranges 3, 3′, 3″ the valve current is increased to maximum current strength (100%). In the heating pauses 4, 4′, 4″ between the heating pulses, the coil current is disabled so that the coils can cool down. A heating pause with a duration of several minutes represents the end of the heating period.

1. Method of actuating a braking device for motor vehicles with electrically actuatable hydraulic valves and a hydraulic pump, wherein one or more existing valve coils necessary for hydraulic controlling functions are actuated for the purpose of electrically heating one or more support members accommodating these coils, for longer periods of time than is necessary for the control function and/or in periods in which it is not necessary for the control function,
characterized in that at least one first heating period is performed, with the heating period comprising a first heating pulse followed by a heating pause and at least one further heating pulse.

2. Method as claimed in claim 1,
characterized in that after the first heating period at least one temperature measurement is carried out, and no temperature measurement is carried out in particular within the heating periods.

3. Method as claimed in claim 1 or 2,
characterized in that the first heating period is started immediately after the engine's ignition is switched on, or after a person has entered the vehicle what is detected by a monitoring device.

4. Method as claimed in any one of claims 1 to 3,
characterized in that the first heating period is started when the measured temperature is below a predetermined threshold temperature.

5. Method as claimed in any one of claims 1 to 4,
characterized in that the first or any further heating period comprises invariably predetermined consecutive heating pulses of a predetermined duration and heating pauses of a predetermined duration between the heating pulses.

6. Method as claimed in any one of claims 1 to 5,
characterized in that the values for the duration of the heating pulses and/or the duration of the heating pauses for the individual heating periods are taken from a stored table, or these values are determined in tabular form or functionally by an allocation specification in dependence on the temperature measured before the beginning of the heating period.

7. Method as claimed in any one of claims 1 to 6,
characterized in that the second or any further heating period is started not before and only if the temperature measured by a temperature sensor lies below a predetermined threshold temperature.

8. Method as claimed in any one of claims 1 to 7,
characterized in that if brake control happens in a heating period or a heating pulse, the current heating period or the current heating pulse will be discontinued.

9. Method as claimed in claim 8,
characterized in that before the start of a second or any further heating period after termination it is safeguarded in a heating period or a heating pulse because of brake control that the last heating pause intended in the interrupted heating period is completely maintained.

10. Method as claimed in any one of claims 1 to 9,
characterized in that exclusively that valve coil is heated that is associated with a change-over valve connecting the suction side of the hydraulic pump to a supply reservoir in the energized or actuated heating function.

11. Method as claimed in any one of claims 1 to 10,
characterized in that one or more valve coils of only one of two brake circuits is/are actuated for heating.

12. Method as claimed in any one or more of claims 1 to 11,
characterized in that temperature data of a data bus available in the vehicle are shared in use or used for temperature measurement.

13. Method as claimed in any one or more of claims 1 to 12,
characterized in that measuring elements at assemblies pertaining to the brake circuit, especially temperature sensors arranged in the support member, are shared in use or used for temperature measurement.

14. Method as claimed in any one or more of claims 1 to 13,
characterized in that the actuation of the valves is effected with a current strength appropriate to open the respective valve when it is normally closed or, respectively, close it when it is normally open.

15. Method as claimed in any one or more of claims 1 to 14,
characterized in that the pulse length and the current strength is chosen such that the energized valve is not yet switched mechanically.

16. Braking device for motor vehicles, especially a hydraulic brake system,
characterized in that a method as claimed in at least one or claims 1 to 15 is implemented in an electronic processing unit of the brake control unit.
